(19) United States
(12) Patent Application Publication
(10) Pub. No.: US 2010/0124628 A1
(43) Pub. Date: May 20, 2010

(54) Geosynthetic Assembly

(75) Inventor: Yu Hsien Ho, Taichung Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Gold-Joint Industry Co., Ltd., Taichung Hsien (TW)

(21) Appl. No.: 12/274,290

(22) Filed: Nov. 19, 2008

(51) Int. Cl. B32B 7/00

(52) U.S. Cl. 428/98

(57) ABSTRACT

A geosynthetic assembly includes: a first geosynthetic unit including a first body, and a first connector having a plurality of first interlocking members which define respectively first through-holes; a second geosynthetic unit including a second body, and a second connector having a plurality of second interlocking members which define respectively second through-holes, the first and second interlocking members being alternately disposed such that the first and second through-holes are aligned to form a passageway; and a connecting member extending through the passageway.

### BACKGROUND OF THE INVENTION

1. Field of the Invention

This invention relates to a geosynthetic assembly, more particularly to a geosynthetic assembly including a plurality of first and second interlocking members that form a continuous passageway for a connectoring member to extend therethrough, such that first and second bodies of the geosynthetic assembly may be easily and quickly interconnected.

2. Description of the Related Art

Conventional geosynthetics, which include geotextiles and geogrids, are generally manufactured to a predetermined size. In use, a predetermined number of geosynthetics are interconnected in order to obtain a geosynthetic assembly of a desired size.

FIG. 1 shows a conventional geotextile assembly 10 including a first fabric 101 and a second fabric 102, which are interconnected by sewing, such as by using a Z seam, a J seam, a prayer seam or a butterfly seam. However, such sewing is complicated and time-consuming.

FIG. 2 shows a conventional geogrid assembly 1 including a first geogrid body 11, and a second geogrid body 12 that is disposed on and that overlaps the first geogrid body 11. The overlapping portions of the first and second geogrid bodies 11, 12 are interconnected using connectors 13, e.g., metal anchorages, plastic strips, or buckles. However, labor-intensive and time-consuming processes are associated with the use of such connectors 13. In addition, when the first and second geogrid bodies 11, 12 are made from a material having insufficient strength, the interconnection between the first and second geogrid bodies 11, 12 is weak.

FIG. 3 shows another geogrid assembly 2 including first and second geogrid bodies 21, 22. The first geogrid body 21 is disposed on and overlaps the second geogrid body 22. The first and second geogrid bodies 21, 22 are interconnected using a steel bar 23, which is weaved through the first and second geogrid bodies 21, 22 where the same overlap. However, such interconnection of the first and second geogrid bodies 21, 22 is difficult and time-consuming.

### SUMMARY OF THE INVENTION

Therefore, an object of the present invention is to provide a geosynthetic assembly that can overcome the aforesaid drawbacks associated with the prior art.

According to the present invention, a geosynthetic assembly comprises: a first geosynthetic unit including a first body, and a first connector connected to the first body and having a plurality of first interlocking members which are spaced apart from each other along a direction and which define respectively first through-holes; a second geosynthetic unit including a second body, and a second connector connected to the second body and having a plurality of second interlocking members which are spaced apart from each other along the direction and which define respectively second through-holes, the first and second interlocking members being alternately disposed along the direction such that the first and second through-holes are aligned along the direction to form a passageway that extends along the direction; and a connecting member extending through the passageway.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary schematic top view of a conventional geotextile assembly, illustrating interconnection of first and second geotextile bodies by sewing;

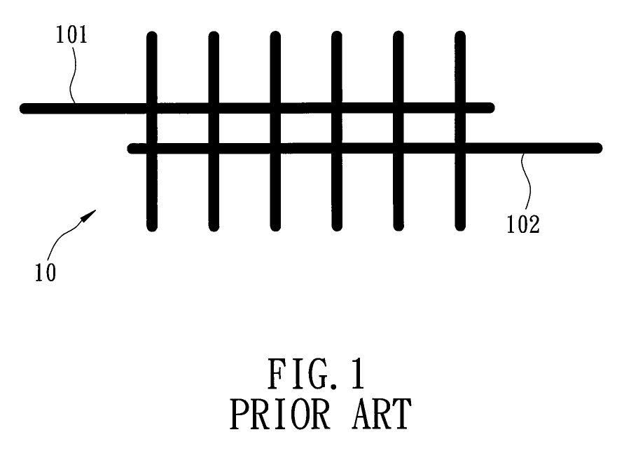

FIG. 2 is a fragmentary schematic top view of a conventional geogrid assembly, illustrating interconnection of first and second geogrid bodies by anchorages;

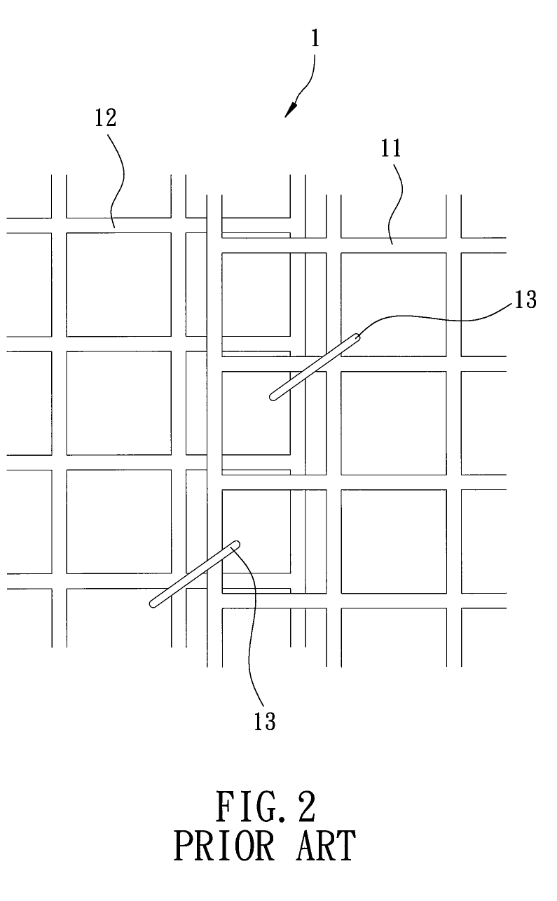

FIG. 3 is a fragmentary schematic top view of another conventional geogrid assembly, illustrating interconnection of first and second geogrid bodies by a steel bar;

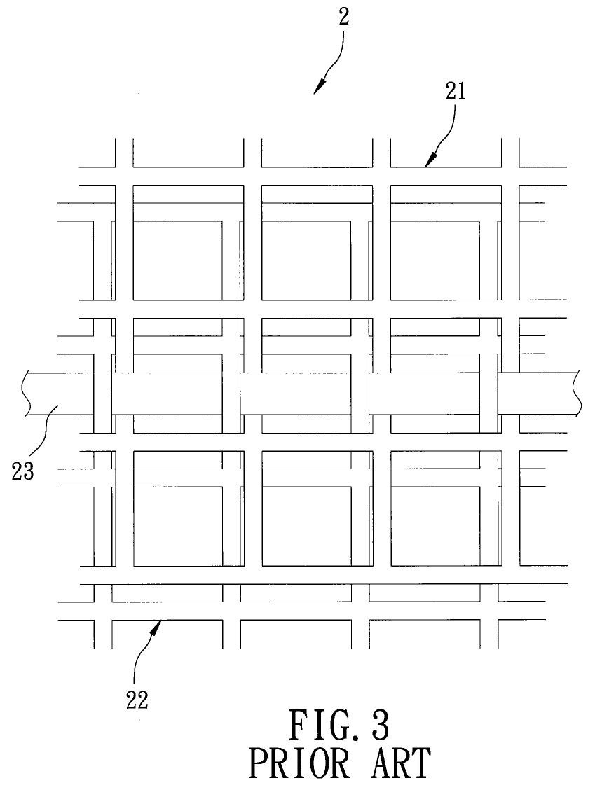

FIG. 4 is a fragmentary exploded perspective view of the first preferred embodiment of a geosynthetic assembly according to this invention;

FIG. 5 is a fragmentary assembled perspective view of the first preferred embodiment;

FIG. 6 is a fragmentary assembled perspective view of the first preferred embodiment, illustrating a connecting member fixed on an anchoring unit; and

FIG. 7 is an assembled perspective view of the second preferred embodiment of a geosynthetic assembly, which could be a geotextile assembly, according to this invention.

### DETAILED DESCRIPTION OF THE PREFERRED EMBODIMENTS

Before the present invention is described in greater detail with reference to the accompanying drawings, it should be noted herein that like elements are denoted by the same reference numerals throughout the disclosure.

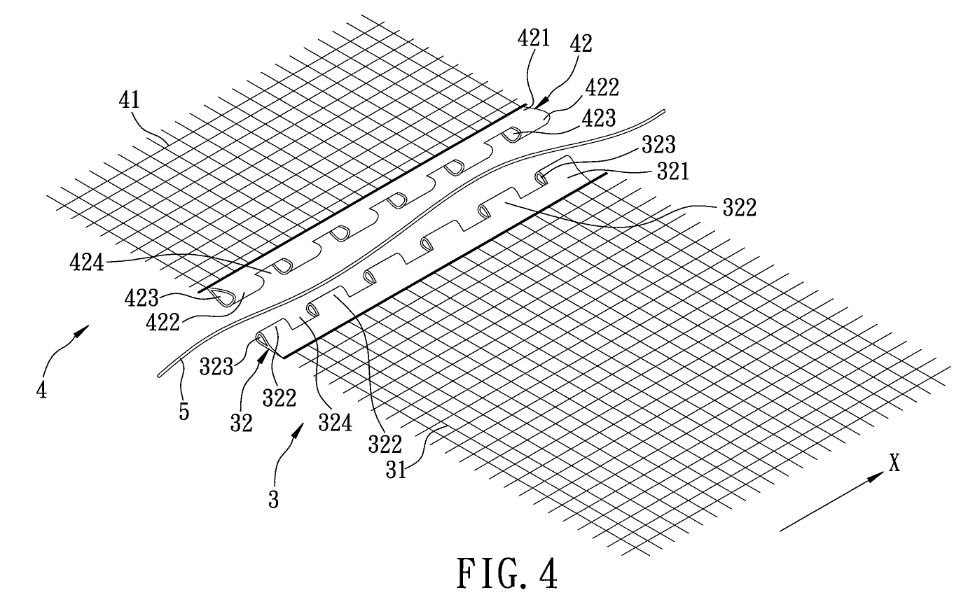

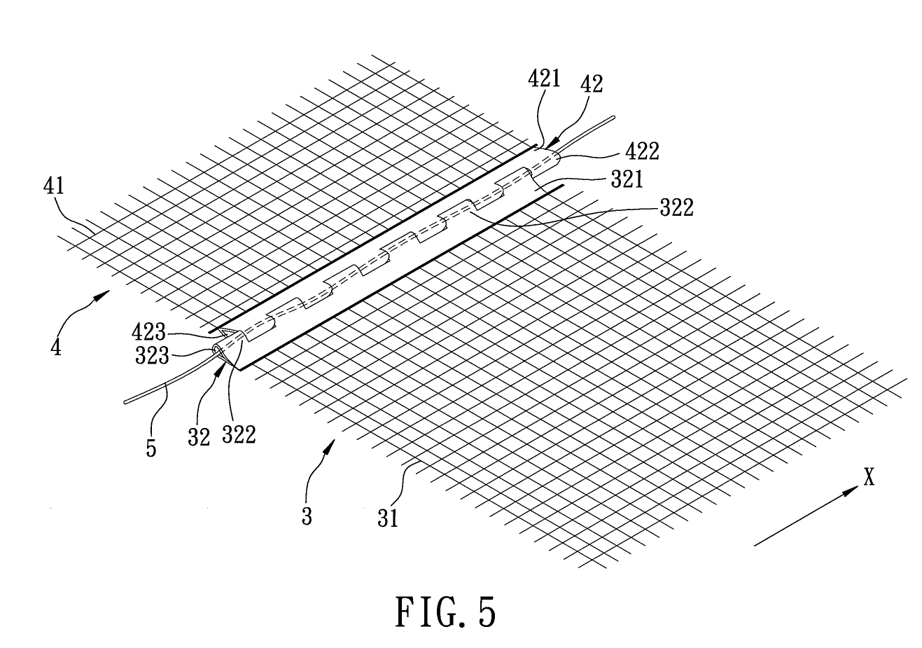

FIGS. 4 and 5 illustrate the first preferred embodiment of a geosynthetic assembly according to this invention.

The geosynthetic assembly includes: a first geosynthetic unit 3 including a first body 31, and a first connector 32 connected to the first body 31 and having a plurality of first interlocking members 322 which are spaced apart from each other along a direction (X) and which define respectively first through-holes 323; a second geosynthetic unit 4 including a second body 41, and a second connector 42 connected to the second body 41 and having a plurality of second interlocking members 422 which are spaced apart from each other along the direction (X) and which define respectively second through-holes 423, the first and second interlocking members 322, 422 being alternately disposed along the direction (X) such that the first and second through-holes 323, 423 are aligned along the direction (X) to form a passageway that extends along the direction (X); and a connecting member 5 extending through the passageway so as to interconnect the first and second geosynthetic units 3, 4.

In this embodiment, a plurality of first recesses 324, each of which is defined between each two adjacent ones of the first interlocking members 322, are sized such that each two adjacent ones of the first interlocking members 322 tightly receive a respective one of the second interlocking members 422 therebetween, and a plurality of second recesses 424, each of which is defined between each two adjacent ones of the second interlocking members 422, are sized such that each two adjacent ones of the second interlocking members 422 tightly receive a respective one of the first interlocking members 322 therebetween. As a result, the passageway is substantially continuous along the direction (X), as shown in FIG. 5.

In this embodiment, the first connector 32 further has a first connecting portion 321 connected to the first body 31 and extending between the first body 31 and the first interlocking members 322, and the second connector 42 further has a second connecting portion 421 connected to the second body 41 and extending between the second body 41 and the second interlocking members 422.

In this embodiment, the first and second connectors 32, 42 are connected to the first and second bodies 31, 41 by sewing. In other embodiments, the first and second connectors 32, 42 are connected to the first and second bodies 31, 41 by adhering the same thereto, by fusing the first and second connectors 32, 42 to the first and second bodies 31, 41, or by integrally forming the first and second connectors 32, 42 with the first and second bodies 31, 41.

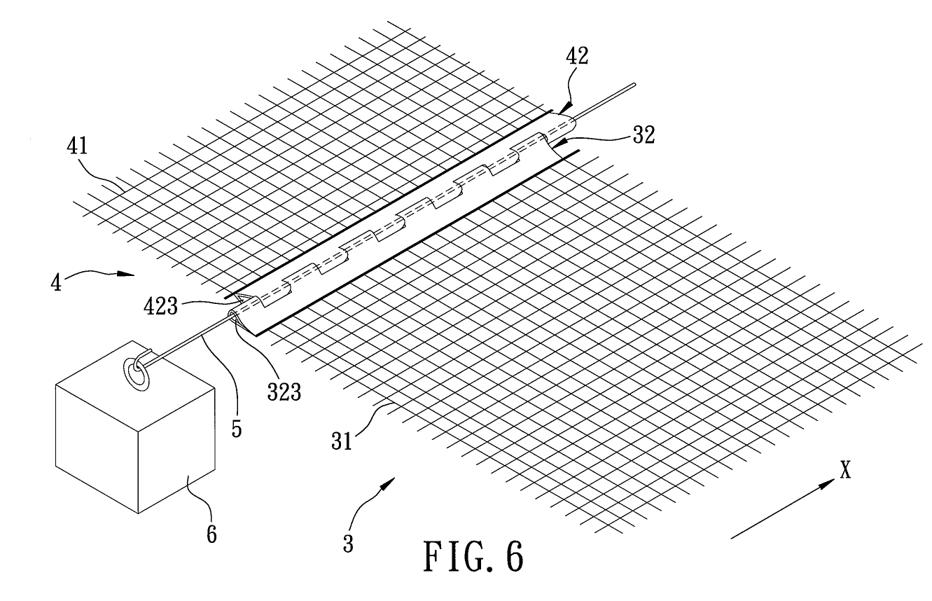

In some embodiments, with reference to FIG. 6, the geosynthetic assembly further includes an anchoring unit 6 disposed next to the first and second geosynthetic units 3, 4. One end of the connecting member 5 is connected to the anchoring unit 6 so as to prevent undesired removal of the connecting member from the first and second through-holes 323, 423.

Preferably, the anchoring unit 6 is made of concrete, but may be made of another material.

Preferably, the connecting member 5 is one of a rope and a steel rod.

In this embodiment, the first and second bodies 31, 41 of the first and second geosynthetic units 3, 4 are made from a stiff material having a grid-like structure. That is, in this embodiment, each of the first and second bodies 31, 41 is formed as a geogrid.

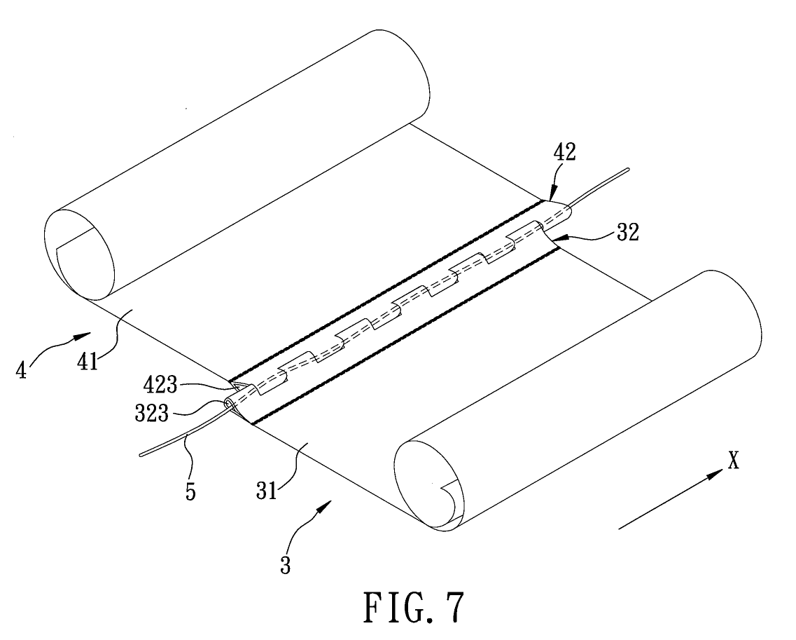

As shown in FIG. 7, the second preferred embodiment of the geosynthetic assembly according to the present invention has a structure similar to that of the first preferred embodiment, but differs from the first preferred embodiment in that the first and second bodies 31, 41 of the first and second geosynthetic units 3, 4 are made from a fabric material. That is, in the second preferred embodiment, each of the first and second bodies 31, 41 is formed as a geotextile.

By disposing alternately the first and second interlocking members 322, 422 along the direction (X) such that the first and second through-holes 323, 423 are aligned along the direction (X) to form the passageway for the connecting member 5 to extend therethrough, the aforesaid drawbacks associated with the prior art can be eliminated.

With the invention thus explained, it is apparent that various modifications and variations can be made without departing from the spirit of the present invention. It is therefore intended that the invention be limited only as recited in the appended claims.

What is claimed is:

1. A geosynthetic assembly comprising:
a first geosynthetic unit including
a first body, and
a first connector connected to said first body and having a plurality of first interlocking members which are spaced apart from each other along a direction and which define respectively first through-holes;
a second geosynthetic unit including
a second body, and
a second connector connected to said second body and having a plurality of second interlocking members which are spaced apart from each other along the direction and which define respectively second through-holes, said first and second interlocking members being alternately disposed along the direction such that said first and second through-holes are aligned along the direction to form a passageway that extends along the direction; and
a connecting member extending through said passageway.

2. The geosynthetic assembly of claim 1, wherein each two adjacent ones of said first interlocking members tightly receive a respective one of said second interlocking members therebetween, and each two adjacent ones of said second interlocking members tightly receive a respective one of said first interlocking members therebetween, such that said passageway is substantially continuous along the direction.

3. The geosynthetic assembly of claim 1, wherein said first connector further has a first connecting portion connected to said first body and extending between said first body and said first interlocking members, and said second connector further has a second connecting portion connected to said second body and extending between said second body and said second interlocking members.

4. The geosynthetic assembly of claim 1, further comprising an anchoring unit disposed next to said first and second geosynthetic units, one end of said connecting member being connected to said anchoring unit.

5. The geosynthetic assembly of claim 1, wherein said connecting member is one of a rope and a steel rod.

6. The geosynthetic assembly of claim 1, wherein said first and second bodies of said first and second geosynthetic units are made from a soft material.

7. The geosynthetic assembly of claim 6, wherein said first and second bodies of said first and second geosynthetic units are made from a fabric material.

8. The geosynthetic assembly of claim 6, wherein said first and second bodies of said first and second geosynthetic units have a grid-like structure.

9. The geosynthetic assembly of claim 1, wherein said first and second bodies of said first and second geosynthetic units are made from a stiff material having a grid-like structure.
